(19) United States
(12) Patent Application Publication
(10) Pub. No.: US 2003/0017003 A1
(43) Pub. Date: Jan. 23, 2003

(54) Modular migration fishway

(76) Inventor: Robert J. Ragsdale, Annapolis, MD (US)

Correspondence Address: Joseph M. Gusmano, Weinstock, Friedman & Friedman, P.A., 4 Reservoir Circle, Baltimore, MD, 21208, US

(21) Appl. No.: 10/174,892

(22) Filed: Jun. 19, 2002

Related U.S. Application Data
(60) Provisional application No. 60/299,210, filed on Jun. 19, 2001.

(51) Int. Cl. E02B 3/00; E02B 8/08; A01K 61/00

(52) U.S. Cl. 405/80; 405/81; 119/219

(57) ABSTRACT

A novel fishway apparatus comprises a channel directed generally above and over a dam or other obstruction, constructed from a plurality of components. Each component incorporates one or more baffles, each baffle having a center passage situated in the center of a dome structure. The fishway extends vertically below the normal elevation of the waterway on both sides of the obstruction, so that the fishway may be flooded by establishing a vacuum in the air pocket formed within the fishway. A well known and commercially available vacuum pump system may be used to establish this vacuum.

### CROSS REFERENCE TO RELATED APPLICATIONS

This application is from provisional application Ser. No. 60/299,210 filed on Jun. 19, 2001, incorporated herein by reference.

### BACKGROUND OF THE INVENTION

1. Field of the Invention

The present invention relates to fishways, and in particular, to an apparatus and method for effecting the movement of migratory and anadromous fish over dams and like structures so that such fish may migrate between the ocean and upstream bodies of water such as spawning streams.

2. Description of the Background

Throughout most of the 20^{th} Century, nations with active river systems throughout the world have dammed most of these rivers, sometimes at several points along their lengths, for the purpose of generating hydroelectric power, mitigating flood damage, storing water for future use, and creating areas for water recreation. In many instances, these dam projects have disrupted the natural process and movement of migratory and anadromous fish by placing obstacles between them and their destination. Anadromous fish such as some species of salmon are species that ascend from the sea to spawning areas in river systems to breed before ascending again into the ocean.

More recently, there has been great interest in restoring the habitats of these and other species by removing dam projects and restoring the river system to its original geography. This is a very controversial decision, since many communities have come to depend on the electricity, protection from floods, water, and tourism that the dammed river systems provide. Hydroelectric power capacity lost to these projects must be replaced by other sources, mainly nuclear power and fossil fuels. Finally, there is a substantial cost associated with demolition of the dams themselves, and relocation of people and structures affected by the removal project.

For several decades, means of permitting the movement of migratory and anadromous fish through or around a dam system have been devised, with varying success. These fishways may generally be separated into two types: powered means, wherein a powered mechanical means of raising the fish, with or without the surrounding water, is operated, and natural means, in which the fishway is flooded by the natural movement of water, forming a gradual passage for the movement of fish.

Of powered means, the prior art contains many methods, but none that would not require substantial maintenance of continuously running electrical machinery. The power requirements are substantial when the immense mass of water is moved along with the fish. By way of example, one prior art apparatus for the movement of fish across an elevation separated by a dam or levee found in the prior art include mechanical apparatus in the nature of an escalator which houses fish in a traveling compartment. Methods that separate the fish from the water and then lift them, even for a brief time, are likely to be detrimental to the health and safety of the fish, which is in turn detrimental to a primary object of these inventions. This is why the vast majority of fishways in service are of the natural type.

Natural means of fishway, also commonly referred to as fish ladders, may be further divided into the following types:

(a) Weir type, in which weirs or baffles separate a series of progressively elevated pools over which fish ascend by either swimming or jumping over each weir between adjacent pools. Such weir type fishways have the advantage that they mimic the natural whitewater conditions that some anadromous species rely on for spawning purposes. It is believed that this natural process promotes the natural selection of the strongest specimens of these species. However, these types do not permit other species whose instincts do not include jumping and rushing obstacles to climb, they do not operate in low water conditions, and they require a large volume of water to operate.

(b) Orifice type, in which orifices are formed at the base of baffles or weirs through which the fish can pass. Such orifice type have the advantage that they will operate in a lower water condition than the weir type, although seasonal water level changes dictate that these type will ultimately cease to operate as well. While they permit more species to enter through orifices engineered to accept fish of the species found in the geography of the particular application, they also require a large volume of water to operate.

(c) Denil type, in which a straight, sloping channel has vanes fitted along the sides and the bottom designed to cause a high degree of turbulence that reduces water velocity. Again, this is a desirable type for those species of anadromous fish that rely on turbulent conditions to swim upstream to spawning fields, but not for other species. A denil is not so much an obstruction to flow as a means to create turbulence in a stream to reduce its velocity, and its effectiveness in so doing is limited.

These types of natural fishway collectively have two characteristics in common. First, the course of such a natural fish ladder of any of the above types must necessarily be quite long so that its grade is sufficiently shallow that the fish can overcome it. Many dam systems do not have a suitable site along the periphery for the installation of a conventional fish ladder, and some dam systems are in populated areas and require the acquisition of real estate to incorporate a fish ladder. Consequently, it would be highly desirable to provide a method and apparatus for a fishway that permits the fish to pass more directly between elevations.

Second, the weirs, orifices, and vanes employed do not present a fully closed cross section to the oncoming water, which makes them less efficient at reducing velocity, and therefore the volume of the water running their course. The more water that is employed in the fishway, the more potential hydroelectric power is wasted, and the more difficult to maintain a reservoir for water supply or recreation. Consequently, it would be highly desirable to devise an obstruction for a natural fishway which presents a fully obstructed cross section, yet can still be navigated by fish of the particular species desired.

In light of the above, there is a compelling need to provide a method and apparatus that will successfully permit the natural migration of migratory and anadromous fish across the elevation difference of the large number of existing dams, without extensive reengineering and modification of those structures. There is a further need for an apparatus that is easily assembled at the site of the dam so as to minimize the effect on the operation of the dam. A system of standardized modules is therefore indicated. The prior art includes fishways that are modular in structure, but do not have the other features herein described.

### SUMMARY OF THE INVENTION

In light of the foregoing, it is therefore a primary object of the present invention to provide a fishway for anadromous and migratory fish to pass over and across a dam or other obstruction to fish movement in either direction.

It is another primary object of the present invention to provide a fishway apparatus that is amenable to installation at the site of an existing dam, thus obviating the need for removal or modification of the dam.

It is another primary object of the present invention to provide a fishway that will operate using the siphon effect.

It is a further object of the present invention to provide a fishway that comprises a system of modular components that can be engineered and constructed prior to use in a controlled environment and lifted into place so that construction time and cost of a fishway apparatus are minimized.

It is a further object of the present invention to provide a fishway comprising a baffle that simultaneously minimizes the flow of water through a fishway while permitting anadromous and migratory fish to traverse a dam or other obstruction.

It is a further object of the present invention to provide a natural fishway that will operate at any gradient depending upon the conditions of the site the fishway.

In light of the above objects, a novel fishway comprises a channel directed generally above and over a dam or other obstruction, constructed from a plurality of components. Each component incorporates one or more baffles, each baffle having a center passage situated in the center of a dome structure. The fishway extends vertically below the normal elevation of the waterway on both sides of the obstruction, so that the fishway may be flooded by establishing a vacuum in the air pocket formed within the fishway. A well known and commercially available vacuum pump system may be used to establish this vacuum. The differences in elevation across the dam or other obstruction will cause a flow to initiate from the upper elevation to the lower elevation; however, the novel baffles of the present invention serve to reduce this flow by at least an order of magnitude. In applications where the stable body of water to establish the vacuum is a distance downstream of the dam or obstruction, the fishway continues from a downstream elevated column, across the waterway bed or other suitable foundation, and terminates where water sufficient to establish a vacuum may be found.

### BRIEF DESCRIPTION OF THE DRAWINGS

These and other objects, features, and advantages of the present invention will become more apparent from the following detailed description of the preferred embodiments and certain modifications thereof when taken together with the accompanying drawings in which:

FIG. 1 is a cross section of a fishway 1.10 according to a preferred embodiment of the present invention.

FIG. 2 is a cross section of a traversing portion 1.30 of the fishway of FIG. 1.

FIG. 3 are cross sections an plan sections of exemplary ascending portion modules 1.22 and 1.24 of the fishway of FIG. 1.

FIG. 4 is a cross section of a fishway 2.10 according to a second preferred embodiment of the present invention.

FIG. 5 is a cross section of an exemplary descending portion module 2.42 of the fishway of FIG. 4.

FIG. 6 is a cross section of another exemplary descending portion module 2.44 of the fishway of FIG. 4.

FIG. 7 is a cross section and plan view of a baffle 70 according to another embodiment of the present invention.

FIG. 8 is a schematic diagram of an exemplary vacuum pump system 80 in a preferred embodiment of the present invention.

### DETAILED DESCRIPTION OF THE PREFERRED EMBODIMENTS

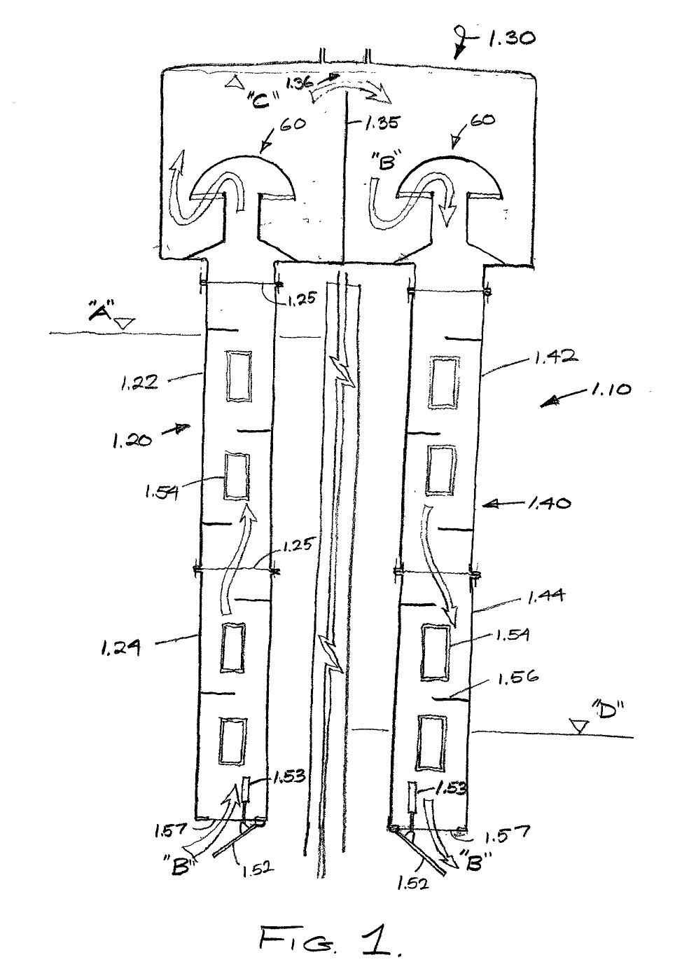

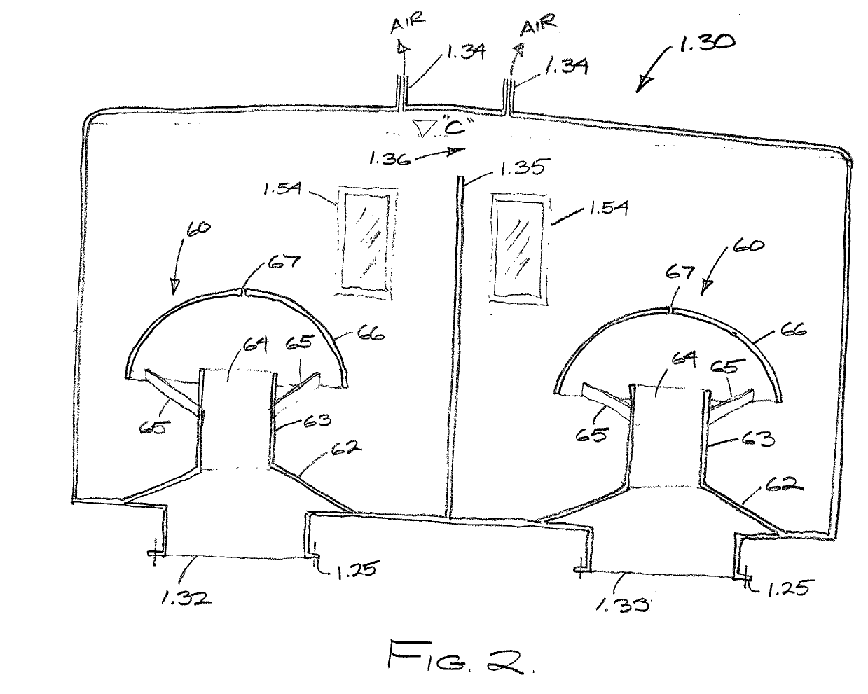

Referring now to FIG. 1, a fishway 1.10 of the present invention comprises an ascending portion 1.20, which communicates with a first body of water that is upstream, or of the same or higher elevation, represented by a water level A, a traversing portion 1.30, into which water enters from ascending portion 1.20 as shown by streamlines B, and a descending portion 1.40, which communicates with a second body of water that is downstream, or of the same or lower elevation as the first body of water, represented by water level D, and into which water enters from the traversing portion 1.30 as shown by streamlines B, and exits into the second body of water. This movement of water from the first body of water to the second body of water occurs due to the phenomenon commonly referred to as the siphon effect. Gravity acts on the water to pull it through the fishway 1.10 from the first body of water to the second body of water.

In this embodiment of the invention the water must be pulled into the fishway 1.10 to initiate the siphon effect. The water level in the fishway is raised to a level represented by water level C in this particular embodiment, which is sufficiently high to pass over a weir 1.35 through an aperture 1.36 that is also of sufficient size for fish of the desired species to pass. There is nothing in the foregoing to prevent an aperture of any other type, or for the weir to be replaced with a baffle of other type, so long as it is calculated to allow the initiation of the siphon effect and permit fish of the desired species to pass.

Further in this embodiment of the present invention, ascending portion 1.20 is shown as comprising exemplary ascending portion modules 1.22 and 1.24, and descending portion 1.40 is shown as comprising descending portion modules 1.42 and 1.44. Each ascending portion module 1.22 and 1.24 and descending portion module 1.42 and 1.44 incorporates one or more baffles 1.56, which are shown as half moon baffles in the present embodiment, but maybe of any type that admits water and permits the passage of fish of the desired species.

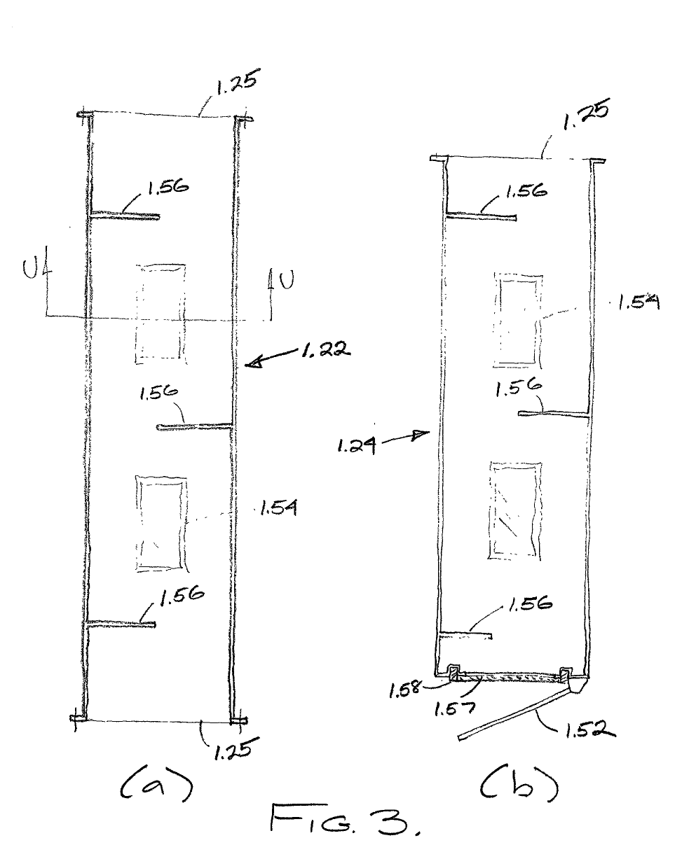

Referring now to FIG. 2, and in a preferred embodiment of the present invention, a traversing portion of a fishway is 1.30 situated over the top of a dam or other obstruction to the migration of fish and is supported by any conventional frame of sufficient strength to support the weight of the structure, the weight and dynamic force of the moving water, and any environmental loads. Steel, fiber reinforced plastic, and aluminum are candidates for the construction material. A baffle 60 is placed over each of an ascending aperture 1.32 and a descending aperture 1.33. The chamber formed by the module above the baffles is of sufficient size to permit the passage of fish of the desired species.

Baffle 60 is an important but not necessary feature of the present invention, because it is designed to reduce the velocity of water across it in either direction to an extent not contemplated by the prior art and through the fishway while still admitting the passage of fish of the desired species. Baffle 60 comprises a base portion 62 that attaches to the walls of the fishway directing the route of water and fish through a tunnel portion 63. At the end of tunnel portion 63 opposite base portion 62 is an aperture 64 which admits water and fish to a dome portion 66. Dome portion 66 is in turn connected to tunnel portion 63 by way of a plurality of struts 65, sufficient to bear the forces of water passing through the baffle 60. In the present embodiment dome portion 66 is shown as hemispherical, but any shape that admits water and the desired species of fish, such as cylindrical, may be used.

Two other features of baffle 60 are significant but not strictly necessary for the operation of the baffle 60. First, aperture 64 of tunnel portion 63 is at an elevation slightly higher than the rim of dome portion 66, so that water passing through baffle 60 is compelled to make an essentially complete reversal in direction as it passes. Second, dome portion 66 is shown with a small hole 67 so that when the fishway is filled air evacuates the dome portion 66 and is not trapped inside. Small hole 67 is intended to be only large enough to admit air and not admit a significant amount of water or to admit fish.

In this embodiment of the invention, traversing portion 1.30 represents the highest elevation in the fishway 1.10. Therefore, it is at the topmost elevation of traversing portion 1.30 that vacuum connections 1.34 are placed, so that the air can be evacuated from the fishway 1.10 up to a level which initiates the siphon effect and admits fish of the desired species, represented by water level C. There is nothing in the foregoing which would preclude evacuating all of the air in traversing portion 1.30, except the practical difficulties of using a vacuum for this purpose. Traversing portion 1.30 is also shown with windows 1.54, which admit ambient light and allow for observation of the fish and the operation of the fishway.

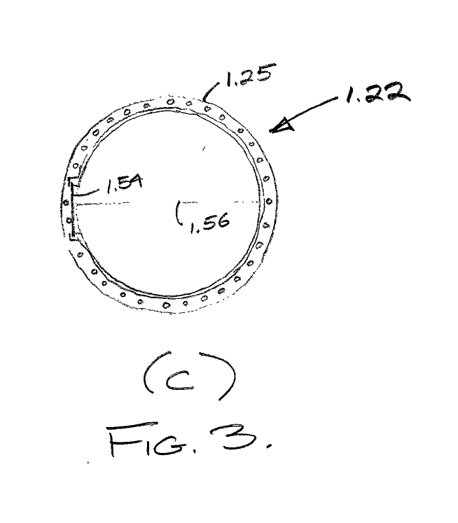

Referring now to FIG. 3, and in the embodiment of FIG. 1, a cross section of exemplary ascending portion modules 1.22 and 1.24 are shown, which are identical to their counterpart descending portion modules 1.42 and 1.44, which similarity and interchangeability is an object of the present invention. In FIG. 3(a) an exemplary ascending portion module 1.22 comprises one or more baffles 1.56 of the half moon type, one or more windows 1.54 admitting ambient light and permitting observation, and at each end a flange 1.25 for connecting this module to the next one along the fishway 1.10.

In FIG. 3(b), another exemplary ascending portion module 1.24 further comprises, in place of a flange, an aperture 1.57 which is intended to be fully immersed in a first body of water or a second body of water, which can be opened or closed by means of a gate 1.52, sealed by a gasket. The gate 1.52 may be closed at the end of both ascending portion 1.20 and descending portion 1.40 by any conventional means such as a hydraulic cylinder 1.53 to evacuate water from the fishway for any purpose, such as cleaning, inspection, etc. FIG. 3(c) is a cross-section through the exemplary ascending portion module 1.22 of FIG. 3(a) showing half moon baffle 1.56 and flange 1.25. In this embodiment of the present invention flanges 1.25 connect to each other by traditional bolted connections commonly used and well know in pipefitting. A gasket is placed between flanges 1.25 of adjoining modules and are bolted together. There is nothing in the foregoing, however, to preclude any other method of attachment of modules that is amenable to the objects of the invention. By way of example, a circumferential collar may be used to hold flanges 1.25 to each other, or flanges 1.25 may be welded or bonded.

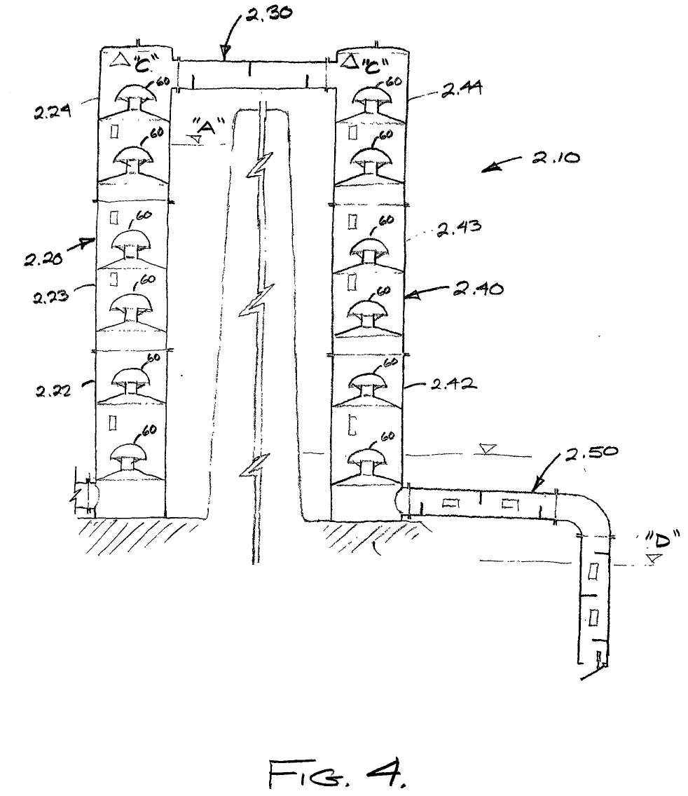

Referring now to FIG. 4, a fishway 2.10 in another embodiment of the present invention comprises an ascending portion 2.20, which communicates with a first body of water that is upstream, or of the same or higher elevation, represented by a water level A, a traversing portion 2.30, into which water enters from ascending portion 2.20 as shown by streamlines B, rising to a level represented by water level C thus initiating the siphon effect, and a descending portion 2.40, which communicates with a second body of water that is downstream, or of the same or lower elevation as the first body of water, represented by water level D, and into which water enters from the traversing portion 2.30 as shown by streamlines B, and exits into the second body of water. The siphon effect is responsible for this movement of water just as in the first embodiment of the fishway 1.10.

In this embodiment, baffles 60 are positioned in wider ascending portions 2.20 and descending portions 2.40, which has the effect of further decreasing the velocity of water through the fishway in applications where a higher change in elevation between the first body of water and the second body of water is present. Furthermore, and in a further embodiment of the present invention, ascending portions 2.20 and descending portions 2.40 may incorporate further traversing portions such as that shown as descending traversing portion 2.50 or ascending traversing portion (not shown) which will engage the first body of water and second body of water at an upstream or downstream location calculated to attract the desired species of fish, or calculated to be immersed fully at times when it is intended to be used.

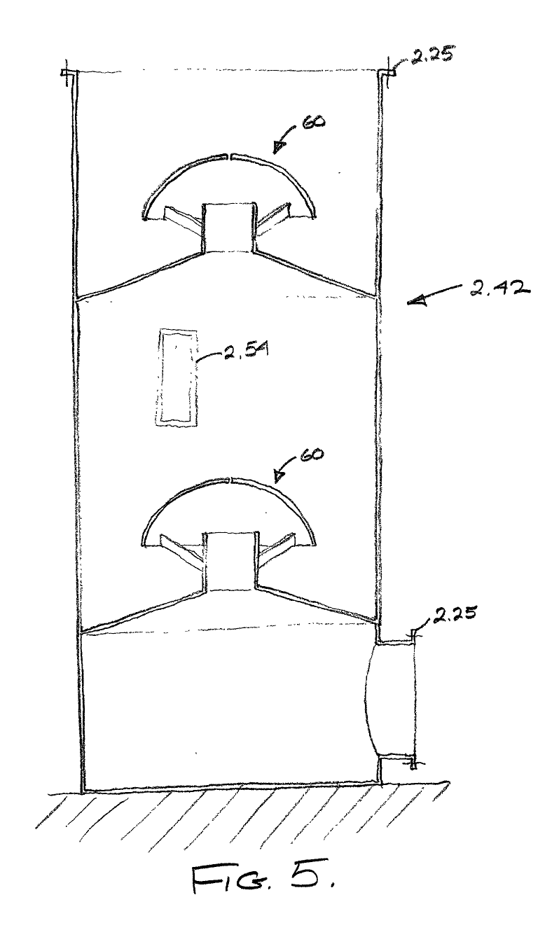

FIG. 5 is a cross section of an exemplary descending portion module 2.42 of the fishway of FIG. 4. In the present embodiment, descending portion 2.42 rests on a fixed foundation to support the weight of the structure, thus relieving the dam or obstruction from bearing the forces created by the fishway.

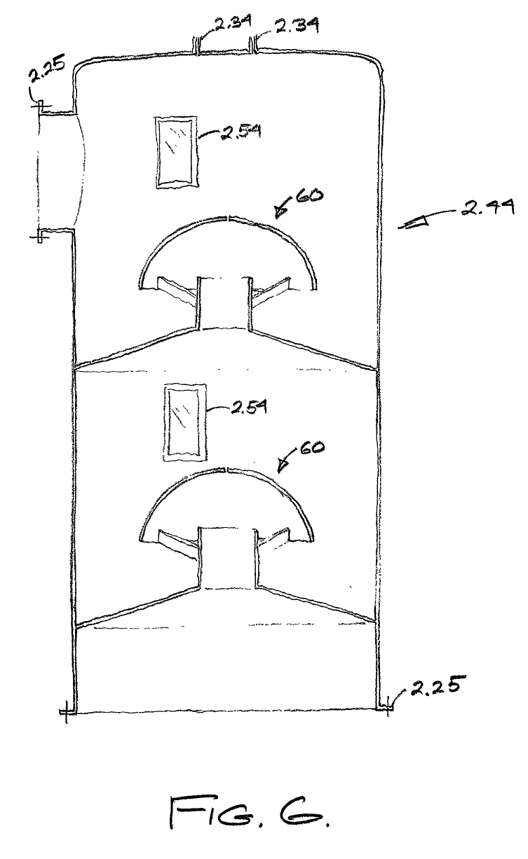

FIG. 6 is a cross section of another exemplary descending portion module 2.44 of the fishway of FIG. 4. In the present embodiment, it is the ascending portions 2.20 and descending portions 2.40 of fishway 2.10 that reach the highest elevation, and so it is to those portions that vacuum connections 2.34 are connected.

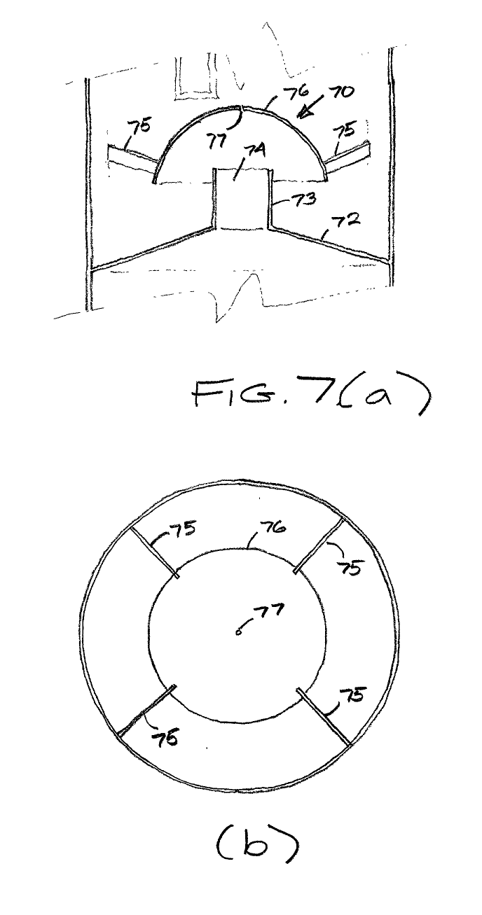

FIG. 7 is a cross section and plan view of a baffle 70 according to another embodiment of the present invention. In this embodiment, dome portion 76 is attached to the wall of the module by struts 75, and not to the tunnel portion 73. This embodiment may be used when structural strength characteristics dictate its use. Dome portion 76 is positioned over base portion 72, tunnel portion 73, and aperture 74 in the same manner as in the prior embodiment of baffle 60.

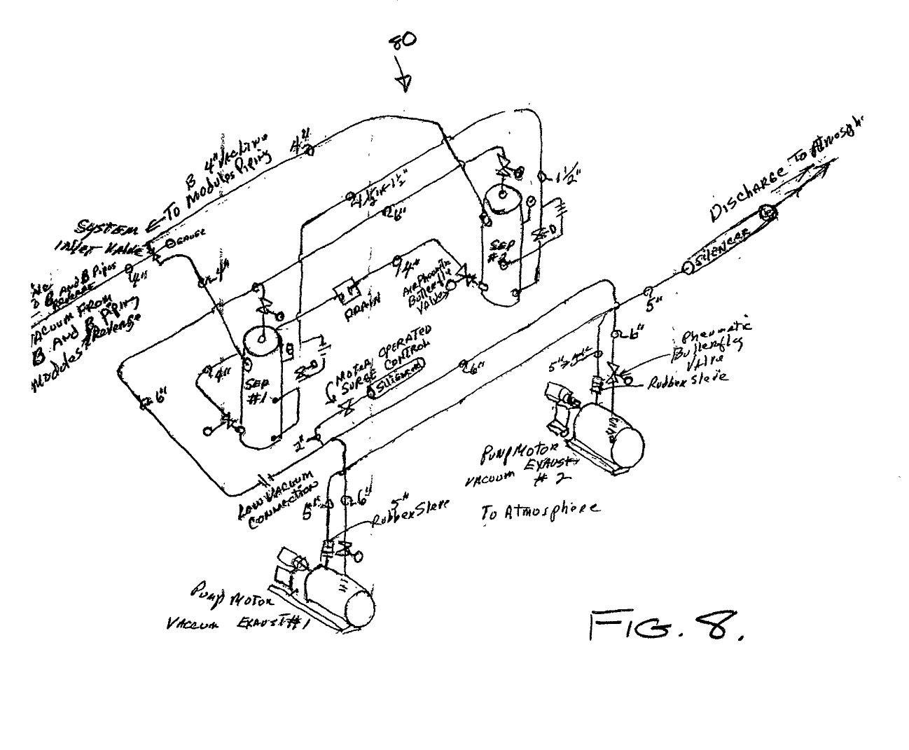

FIG. 8 is a schematic diagram of an exemplary vacuum pump system 80 in a preferred embodiment of the present invention.

It is well known to one of ordinary skill in the art of the present invention that for some migratory and anadromous species of fish, attraction water is an important factor in the efficacy of the fishway. Attraction water is water from the upstream waterway that has the desired combination of a change in temperature, a change in salinity, and a strong flow opposite the direction of travel. The fishway of the present invention naturally provides all of these since when the vacuum is initiated a siphon effect automatically establishes a flow from the upstream waterway to the downstream waterway. The magnitude of this flow is governed by the number and location of the baffles used in a given application.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. In the context of a first body of water and a second body of water, wherein said first body of water is at an elevation equal to or higher than said second body of water, a fishway comprising:
an ascending portion in contact with said first body of water comprising at least one baffle,
a descending portion in contact with said second body of water comprising at least one baffle,
a traversing portion in communication with said ascending portion and said descending portion, admitting water from said first body of water, through said ascending portion, through said traversing portion, and through said descending portion, into said second body of water by way of the siphon effect, and
vacuum means for evacuating air from said ascending portion, said descending portion, and said traversing portion.

2. The fishway of claim 1, wherein said traversing portion further comprises at least one baffle.
